(19) United States
(12) Patent Application Publication
(10) Pub. No.: US 2025/0076099 A1
(43) Pub. Date: Mar. 6, 2025

(54) AUTOMATED PLANT WEIGHT DETERMINATION IN HYDROPONIC GROW SYSTEMS

(71) Applicant: HIPPO HARVEST INC., SAN FRANCISCO, CA (US)

(72) Inventors: ADAM RIESSELMAN, PACIFICA, CA (US); WIM MEEUSSEN, REDWOOD CITY, CA (US)

(21) Appl. No.: 18/824,599

(22) Filed: Sep. 4, 2024

Related U.S. Application Data
(60) Provisional application No. 63/580,705, filed on Sep. 5, 2023.

(51) Int. Cl. G01G 5/02; G01G 19/00; G01G 23/01; G05D 1/656; G05D 111/50

(52) U.S. Cl. CPC G01G 5/02; G01G 19/00; G01G 23/01; G05D 1/656; G05D 2111/52

(57) ABSTRACT

Hardware and computational systems for measuring plant weight in hydroponic grow systems. The combined weight of hydroponic grow modules that grow plants using a small amount of water covering the roots is accessible via automated robotic systems. The individual weights of grow infrastructure, plant mass, and available water are convolved. The amount of water in a growing tray can be estimated separately by slightly tipping the module, allowing water to move to one side, and measuring the weight at each of the corners of the module. After controlling for unevenness of the surface where the module is held, a machine learning model predicts the amount of water in a grow module and, subsequently, the plant mass. Reliable estimation of plant mass and water volume allows for both maintenance of precise amounts of water in growing trays and estimation of harvestable product in the grow space.

### CROSS-REFERENCE TO RELATED APPLICATION

This is a non-provisional application for patent entitled to a filing date and claiming the benefit of earlier-filed U.S. Provisional Patent Application No. 63/580,705, filed Sep. 5, 2023 herein incorporated by reference in its entirety.

### TECHNICAL FIELD

The present disclosure relates generally to agriculture, and more specifically to hydroponic grow systems.

### DESCRIPTION OF RELATED ART

Agriculture has been a staple for mankind, dating back to as early as 10,000 B.C. Through the centuries, farming has slowly but steadily evolved to become more efficient. Traditionally, farming occurred outdoors in soil. However, such traditional farming required vast amounts of space and results were often heavily dependent upon weather. With the introduction of greenhouses, crops became somewhat shielded from the outside elements, but crops grown in the ground still required a vast amount of space. In addition, ground farming required farmers to traverse the vast amount of space in order to provide care to all the crops. Further, when growing in soil, a farmer needs to be very experienced to know exactly how much water to feed the plant. Too much and the plant will be unable to access oxygen; too little and the plant will lose the ability to transport nutrients, which are typically moved into the roots while in solution.

Two of the most common errors when growing are overwatering and underwatering. With the introduction of hydroponics, the two most common errors are eliminated. Hydroponics prevents underwatering from occurring by making large amounts of water available to the plant. Hydroponics prevents overwatering by draining away, recirculating, or actively aerating any unused water, thus, eliminating anoxic conditions.

In addition, hydroponics allows for scaling of growing plants in a controlled environment. However, large scale grow spaces have many limitations. One limitation is the limited ability to obtain certain plant metrics. One such metric is plant weight. Plant weight is an important plant metric for commercial horticultural and agricultural production. It can be used to provide insights into plant yields, plant health, plant growth, and plant morphology. In particular, it is critical for informing operations on the amount of sellable product. It is extremely difficult to accurately obtain plant weight of plants in a large scale grow space using current technology without interfering with the grow process. Thus, there is a need for a system and method for efficiently and accurately determining plant weight of individual plants in large scale hydroponic grow systems.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

Aspects of the present disclosure relate to a system, computer readable medium, and a method. The method comprises picking up a tipping module to allow water to move while being tipped until the water settles to a weight equilibrium. The method also includes recording weight measurements once the water has reached weight equilibrium. Next, the method includes determining a module tipping angle measurement. Then, the method includes transforming the recorded weight measurements obtained at weight equilibrium into a deconfounded tipping module weight by using a machine learning model to remove the influence of the module tipping angle on the recorded weight measurements obtained at weight equilibrium. The method also includes transforming the deconfounded tipping module weight into a predicted water amount using a machine learning model trained on reference water volumes. Last, the method includes obtaining plant weight by subtracting the predicted water amount from a total tipping module weight.

In some embodiments, a database of paired module tipping angle measurements and tipping module weights of tipping modules is used to map module tipping angle measurements to tipping module weights to estimate the influence of linear acceleration on tipping module weight. In some embodiments, a reference database of previously observed module tipping angle measurements is used to inform the direction a tipping module is tipped. In some embodiments, a module tipping angle reference calibration location is used to obtain device-based module tipping angle measurement biases, wherein the biases are subtracted from module tipping angle measurements stored in a reference linear acceleration database. In some embodiments, stored reference pairs of water amounts and tipping module weights of a tipping module with no plants are used to train the machine learning model trained on reference water volumes, the reference pairs being stored at a reference calibration location. In some embodiments, transforming the recorded weight measurements into a deconfounded tipping module weight includes one or more of the following: weighing the tipping module, weighing the tipping module when it is empty, weighing the tipping module and plant support hardware, weighing the tipping module immediately before harvest, weighing the tipping module immediately after harvest, and weighing the tipping module after harvest and after removal of the plant support hardware. In some embodiments, a robot is used for picking up the tipping module and the module tipping angle measurement is derived using an inertial measurement unit (IMU) on the robot. These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments.

FIG. 1 is a block diagram of an example grow module, in accordance with embodiments of the present disclosure.

FIG. 2 is an example of a robotic movement and weighing system, m accordance with embodiments of the present disclosure.

FIG. 3A shows an example of lift tipping hardware, m accordance with embodiments of the present disclosure.

FIG. 3B shows an example of a growing tray alignment component, m accordance with embodiments of the present disclosure.

FIG. 4 shows an example of a plant module tipping process, in accordance with embodiments of the present disclosure.

FIG. 5 shows an example of further processing of sensor data, in accordance with embodiments of the present disclosure.

FIG. 6 shows an example of a tipping structural equation model, in accordance with embodiments of the present disclosure.

FIG. 7 illustrates an example of a deconfounded tipping structural equation model, in accordance with embodiments of the present disclosure.

FIG. 8 illustrates an example of a structural equation effect model, m accordance with embodiments of the present disclosure.

FIG. 9 illustrates another example of a structural equation effect model, m accordance with embodiments of the present disclosure.

FIG. 10 illustrates an example of a data generation procedure calibration model, in accordance with embodiments of the present disclosure.

FIG. 11 illustrates an example of a data generation procedure operations model, in accordance with embodiments of the present disclosure.

FIG. 12 illustrates an example of a machine learning model, in accordance with embodiments of the present disclosure.

FIG. 13 illustrates an example of a quality control statistical model, m accordance with embodiments of the present disclosure.

FIG. 14 illustrates an example of a computer system, configured in accordance with one or more embodiments of the present disclosure.

### DESCRIPTION OF EXAMPLE EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, portions of the techniques of the present disclosure will be described in the context of particular hydroponic grow systems. However, it should be noted that the techniques of the present disclosure apply to a wide variety of different grow systems. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a growing tray in a variety of contexts. However, it will be appreciated that a system can use multiple growing trays while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, plant roots may be connected to nutrient water, but it will be appreciated that a variety of layers, such as grow mediums and buffer mats, may reside between the plant roots and nutrient water. Consequently, a connection does not necessarily mean a direct, unimpeded connection unless otherwise noted.

Hydroponic cultivation allows the growing of plants at a large scale in a controlled environment. For the sake of scale and automation, many hydroponic systems are made up of massive recirculating plumbing systems, where cumbersome plant support hardware ensures plant hydration and nutrition. In nutrient film techniques, water and nutrients are moved through massive plant support hardware, such as growing trays or gutters. In deep water culture, plants are placed in floating plant support hardware in large water and nutrient pods.

While these systems take advantage of grow space real estate and automation, their size and composition both restrict access to the plants, as well as limit what kind of plant metrics can be observed of the plants growing in the grow space. Some of these metrics are critical feedback to growers about plant health. One such metric is plant weight.

Plant weight is an important plant metric for commercial horticultural and agricultural production because it provides insights into plant yields, plant health, plant growth, and plant morphology. In particular, it is critical for informing operations on the amount of sellable product.

As briefly mentioned above, plant weight is one of the plant metrics that is very difficult to measure or obtain in a large scale hydroponic grow system. Placing plants on a scale is the most direct method of assessing their weight. In field production, this is impossible without removing the plant from the soil. In modern hydroponic systems, creating the necessary hardware to measure these values at sufficient precision is difficult to rectify with industrial growing constraints. Moreover, if weight measurements are able to be obtained, plant weight must be deconvolved from all the other hydroponic growing components. Certain modalities for obtaining plant metrics, such as plant imaging, provide an alternative, non-destructive means of obtaining said plant metrics. However, these modalities provide limited insight into plant weight. Since only the canopy of the growing plant is imaged, the density of the plants is difficult to ascertain. Thus, there is a need for a new method of accurately obtaining plant weight without all of the above limitations.

The techniques and mechanisms of the present disclosure provide for new hardware and computational systems that are required to measure plant weight in hydroponic grow systems. According to various embodiments, the combined weight of hydroponic grow modules that grow plants using a small amount of water covering the roots is accessible via automated robotic systems. However, the individual weights of grow infrastructure, plant mass, and available water are convolved. According to various embodiments, the amount of water in a growing tray can be estimated separately by slightly tipping the module, allowing water to move to one side, and measuring the weight at each of the corners of the module. After controlling for unevenness of the surface where the module is held, a machine learning model predicts the amount of water in a grow module and, subsequently, the plant mass. Reliable estimation of plant mass and water volume allows for both maintenance of precise amounts of water in growing trays and estimation of harvestable product in the grow space.

### EXAMPLE EMBODIMENTS

In some embodiments, bountiful, efficient production of crops with hydroponic grow systems requires careful management of water and nutrients. One technique of hydroponic cultivation involves growing plants in a small tray with support hardware and a thin film of water. Maintaining an appropriate level of water is paramount to plant health. Too much water leads to overflowing or sloshing when the tray is moved. Too little water leads to drought stress, uneven growth, and poor nutrient mixing. To be able to make adjustments to individual tray water levels with automated robotic systems, the amount of water in each tray must be constantly monitored. However, tracking these levels across at an industrial scale is a difficult task.

According to various embodiments, in order to build a metric of plant mass statistic of plants growing in a grow space at an industrial scale, the model must satisfy a number of constraints to adapt to a fully automated robotic growing system: making the observation must not destroy the sample; sensors should be brought to each sample to make observations in situ; robot observations are as closely tied to physical constraints and factors as possible; and aberrant samples can be flagged as outliers and removed from data processing. These constraints can be achieved by taking observations while lifting and slightly tipping a grow module.

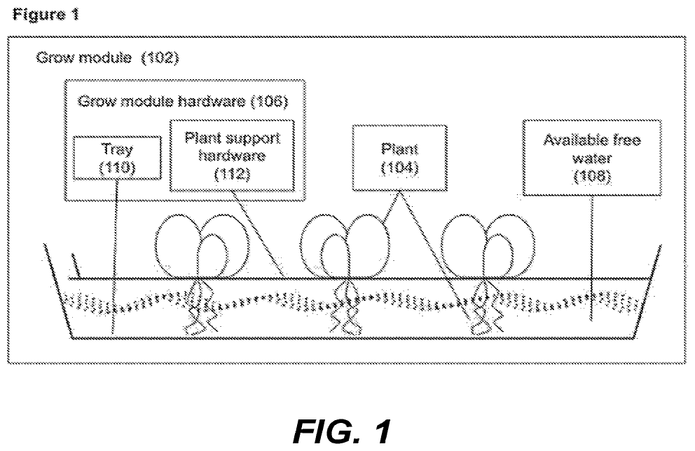

FIG. 1 is a block diagram of an example grow module, in accordance with embodiments of the present disclosure. In some embodiments, one high-throughput measurement of the grow module (102) is to take its weight, as readily measured with an automated robotic system. The weight of this grow module is the sum of three parts: Plant (104), the grow module hardware (106), and the amount of available free water in the growing tray (108). The plant may be composed of, but not limited to, roots, stems, leaves, fruits, and flowers.

In some embodiments, the grow module hardware (106) is composed of a tray (110) and plant support hardware (112). The tray (110) holds water and all grow components as well as provides support for moving and lifting the module. The plant support hardware (112) includes a plastic gutter, composed of multiple narrow channels filled with organic or inorganic grow media. Alternatively, plant support hardware could be foam-based, or any other material or structure, such as baskets or media itself. The weight of these components do not vary over a grow cycle.

In some embodiments, the weight of the grow module hardware (106) is directly observed and constant throughout the lifecycle of the plant. However, the weight of the other components—plant (104) and free water (108)—must be deconvolved from each whole grow module (102) weight measurements.

According to various embodiments, quantifying both plant and water weight is valuable for a number of reasons. In this embodiment of hydroponic growing systems, estimating the amount of water is critical to plant health. At all times, water levels must not be too low, lest the plants desiccate, and water levels must not be too high, to avoid anoxic or flooded conditions experienced by the plant. Accurate water level estimation also ensures the appropriate amount of water is added to the growing tray to avoid overflowing. Knowing the weight of the plant while growing in the grow space is also valuable, as it can be used to estimate the weight of product available out in the grow space.

In some embodiments, directly measuring the weight of the plants (104) and available free water (108) is difficult to execute at scale. Plant roots and available free water are not visible because of the placement of the plant support hardware (112). Moreover, plastics for the grow module hardware (106) must be opaque to limit algae growth. Temporarily removing the plant support hardware (112) during growing to directly observe water levels moves the plant, which can stress and damage the plant. Due to the width-to-height ratio of the tray (110), small changes in the height of the water correspond to proportionally large volumes of water; thus, relying on height to measure volume requires a uniform, level tray as measured with a precise sensor.

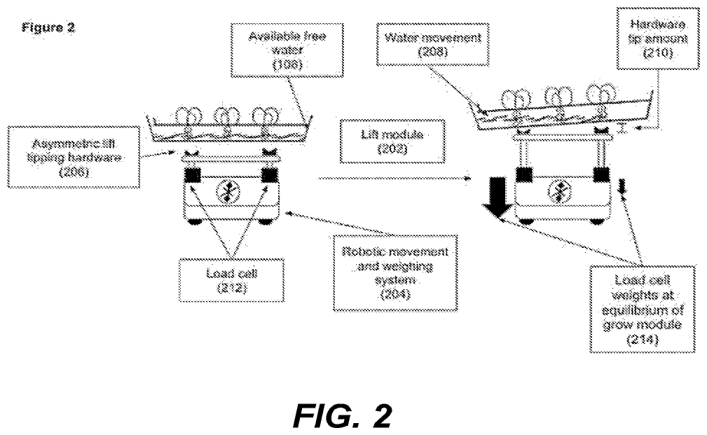

FIG. 2 is an example of a robotic movement and weighing system, in accordance with embodiments of the present disclosure. In some embodiments, disambiguation of the weights of the plant and water weight can be assisted by taking advantage of the physical states of the two components: Available water (108) is a liquid, and free to move about the growing tray (110); while plants are firmly anchored to the grow module hardware (106) in the plant support hardware (112). When a grow module is lifted (202) by an automated robotic movement and weighing system (204) outfitted with asymmetric lift tipping hardware (206), the entire tray is supported by the robotic weighing system (204), with one side of the rectangular tray lower than the rest. Since available water (108) is a liquid, it will travel (208) to the lower side of the growing tray, while the plants (104) will move very little. The difference in height between the upper and lower sides of the tray is determined by the hardware tip amount (210). Larger hardware tip amount (210) will cause more water movement (208).

In some embodiments, the robotic movement and weighing system (204) is outfitted with load cells (212) that are able to measure weight. These load cells are distributed on the robotic movement and weighing system (204) such that they are placed under each of the corners of the grow module (102). After the grow module is lifted up (202), load cell weight observations arc taken at equilibrium (214) once all the water has moved. In some embodiments, this takes ten seconds. In another embodiment, equilibrium is determined when the values of the load cells converge to a stable estimate of weight. Because the water has moved through the tray to the lower side in accordance with the hardware tip amount (210), the weight of that side also increases monotonically with the volume of water. This larger weight is denoted by a large down arrow and recorded by the respective load cells on that side (214). This is compared to the high side of the tray and respective load cells, which record less weight on that side (214).

In some embodiments, lifting the module (202) to cause water movement (208) has additional benefits to water and air quality in this hydroponic method. It encourages mixing of the available water (108), which may help to ensure uniform distribution of both nutrients and toxic products within a grow module. It may also aerate the water, increasing the amount of dissolved oxygen available to plant roots. Finally, it may also move water away from the plant roots (108) and expose them to air, giving the roots access to more oxygen to improve plant health.

In some embodiments, in certain grow module hardware (106) configurations with a large amount of growing media, the movement of water (208) may temporarily moisten plant media, moving water closer to the base of growing plants. Once the grow module (102) is placed back down, the water moves (208) back to its original position. This more closely mimics an ebb-and-flow hydroponic system, ensuring the roots are not fully submerged in water and encouraging additional growing media aeration.

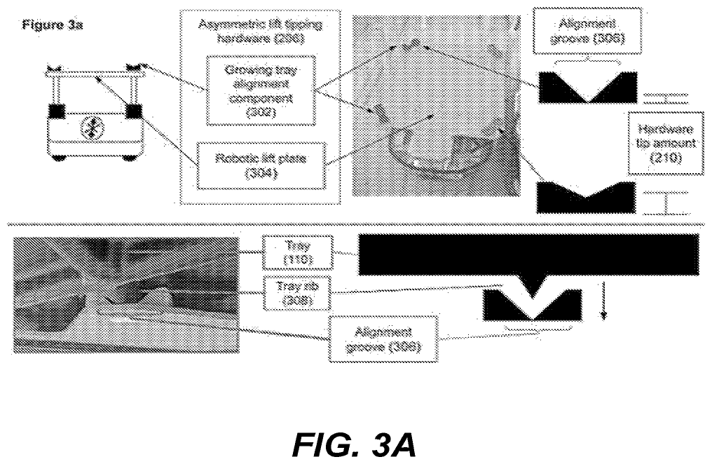

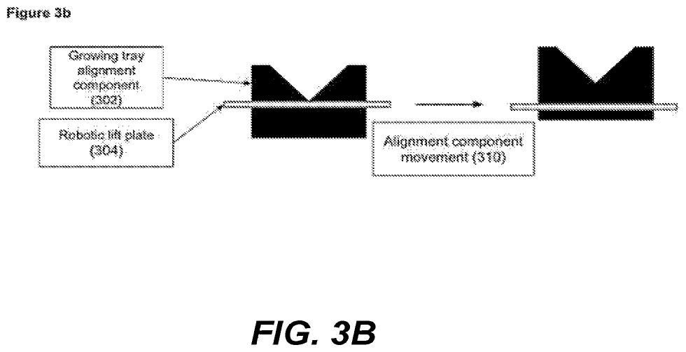

FIG. 3A shows an example of lift tipping hardware, in accordance with embodiments of the present disclosure. In some embodiments, the asymmetric lift tipping hardware (206) is composed of four growing tray alignment component pieces (302) placed at each of the four corners of the rectangular robotic lift alignment plate (304). The alignment component pieces ensure consistent placement of the growing tray (110) when lifting a module (202). The growing tray (110) comes into contact with the alignment groove (306) at a growing tray rip (308). The rib slides down the alignment groove from the force of gravity so the growing tray (110) is picked up the same way each time. Each of the four corresponding load cells (212) are directly below the growing tray alignment pieces (302). Two of the four growing tray alignment component pieces (302) have a larger hardware tip amount (210). In some embodiments, this is achieved by maintaining the width of the alignment groove (306), but decreasing the depth of the groove, thus increasing hardware tip amount (210). This permits similar localization accuracy tolerances of the robotic movement and weighing system (204) between growing tray alignment components (302) of varying hardware tip amount (210). In this embodiment, since the asymmetric lift tipping hardware is constant, the hardware tip amount across grow modules in the grow space is consistent.

FIG. 3B shows an example of a growing tray alignment component, in accordance with embodiments of the present disclosure. In some embodiments, changes in hardware tip amount is achieved by moving the growing tray alignment component (302) vertically with respect to the robotic lift plate (304). In some embodiments, this movement is created by a motorized robotic system. This allows automated, precise movements (310) of the growing tray alignment component (302) to create different hardware tip amounts (210).

In some embodiments, the hardware tip amount is variable instead of constant. This allows for variable tipping, as well as automated transformation of the lift hardware from asymmetric to symmetric. This would allow a robotic movement and weighing system (204) to move a grow module (102) with less risk of water escaping the growing tray (110) or water moving (208) out of the growing tray (110).

In some embodiments, ideally, each module would be lifted on a perfectly flat surface, so the amount of water that moves from the high to low side of the growing tray (110) would solely be determined by the tip hardware amount (210). One approach would be to transport modules to a central weighing station where the floor slope is constant, so any changes in water movement can be attributed solely to hardware tip amount. However, tipping in an industrial setting, sampling speed can be increased by lifting the grow module (202) and taking load cell weight measurements (214) in situ. However, varying floor quality must be taken into consideration, including cracks, sloping, and debris encountered when lifting a module.

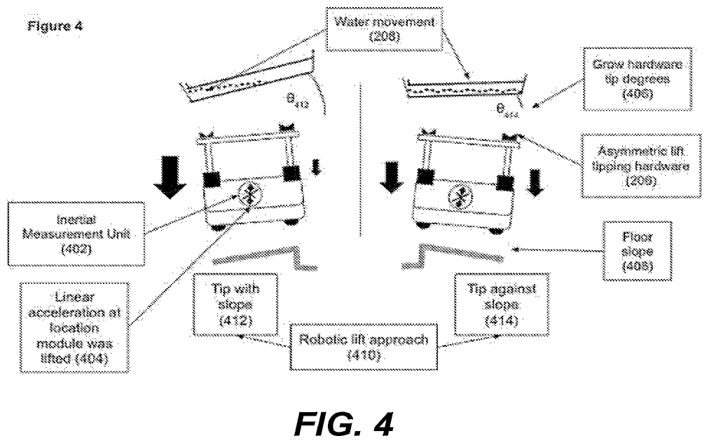

FIG. 4 shows an example of a plant module tipping process, in accordance with embodiments of the present disclosure. In addition to taking the load cell weights (214) after lifting a module (202), an inertial measurement unit (IMU) (402) records the linear acceleration at the location at which the robotic system lifted the module (404). The linear acceleration records the orientation of the robotic weighing hardware with respect to a completely level reference frame. This is important because the grow hardware tip degrees (406) is influenced by both the hardware tip amount and the extent of the floor slope (408), as quantified by changes to the orientation of the robot using linear acceleration values. These orientation values can be used to estimate the amount of water movement due to potentially uneven slope of the floor (408). In some embodiments, the linear acceleration is recorded in three orthogonal components. In another embodiment, recording the orientation of the robot can be amended with additional inertial measurements, including the rotational velocity, or observations made from an on-board gyroscope.

In some embodiments, the asymmetric lift hardware only permits a module to be picked up in two orientations. To get to those poses to lift, the robotic lift approach (4 1 0) defines the trajectory the robotic lift hardware must take to navigate to the desired orientation. In one robotic lift approach, the orientation of the asymmetric tip hardware (206) corresponds to the slope of the floor (4 12), increasing the grow hardware tip degrees θ_412. In the other robotic lift approach (180 degrees in the plane of the floor) the orientation of the asymmetric tip hardware (206) is in the opposite direction of the slope of the floor (414), decreasing the grow hardware tip degrees θ_414. Intuitively, increasing θ leads to more water being moved. This process can be optimized by choosing the robot approach (412, 414) corresponding to the largest θ, argmax (θ_412, θ_414).

In some embodiments, making sure the appropriate grow hardware tip degrees (406) is realized is essential to subsequent data acquisition. First, the floor of the grow space is leveled as much as possible to reduce floor slope (408) to the fullest extent possible. The hardware tip amount (210) of the growing tray alignment component (302) is chosen such that the largest grow hardware tip degrees (406) can be realized without spilling water (108) out of the tray (110).

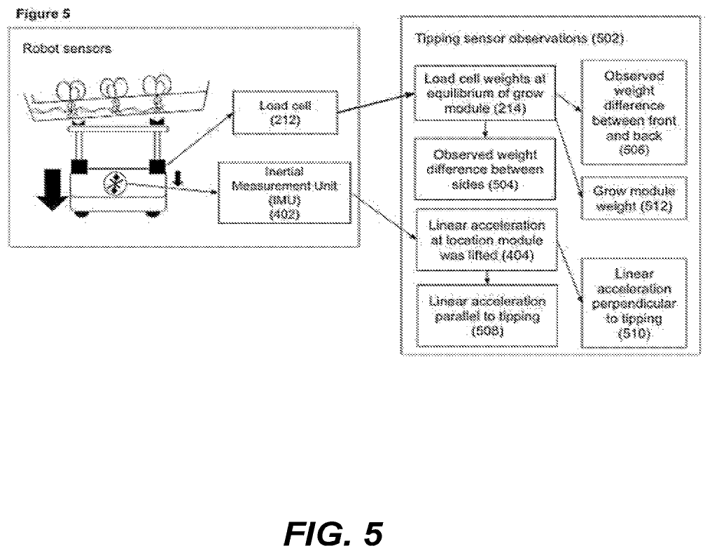

FIG. 5 shows an example of further processing of sensor data, in accordance with embodiments of the present disclosure. In some embodiments, now that necessary actions have been taken and sensor values recorded, the raw sensor measurements during a tipping observation (502) must be further processed for downstream calculations.

In some embodiments, load cell (21 2) measurements g (2 14) can be parameterized as the difference e between the sum of two sets of sensors J and K and the respective weight measurements {g₁ . . . gⱼ} and {g₁ . . . gₖ}:

$$e = ( {\sum }_{j = 1}^{J} {g}_{j} ) - ( {\sum }_{k = 1}^{K} {g}_{k} )$$

In some embodiments, the result from the sets of sensors on the low (J) and high (K) sides with respect to the asymmetric tipping hardware, is the observed difference between sides (504), while the set of sensors perpendicular to the asymmetric tipping hardware, front (J′) and back (K′) result in the observed weight different between front and back (506). Since both the grow hardware (106) and plants (104) do not move and are relatively uniform and symmetric in the grow module, variability in the difference in weights along different axes can be inferred to be due only to water movement. Linear acceleration (404) from the IMU sensor (402) is then parameterized along these two same axes, parallel to tipping (508) and perpendicular to tipping (510), corresponding to the effect seen along the sets of sensors, (J and K) and (J′ and K′), respectively.

In some embodiments, the load cell measurements can also measure the grow module weight (512), t. It is the sum of all load cell measurements:

$$t = ( {\sum }_{j = 1}^{J} {g}_{j} ) + ( {\sum }_{k = 1}^{K} {g}_{k} )$$

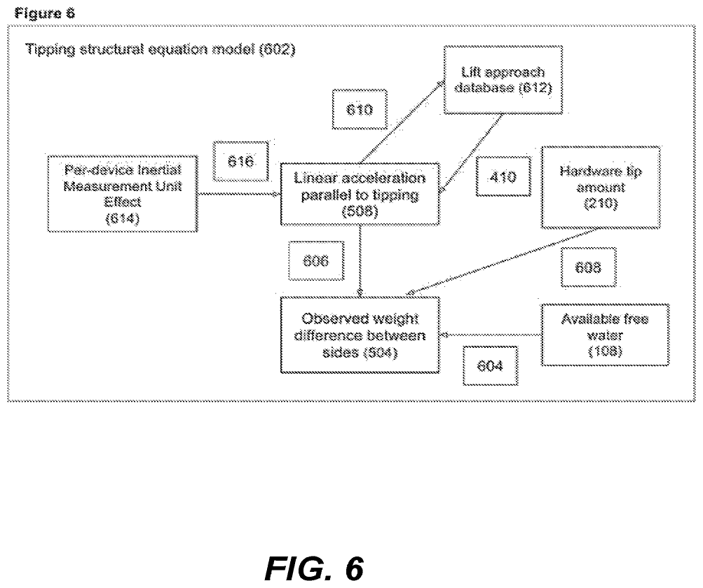

FIG. 6 shows an example of a tipping structural equation model, in accordance with embodiments of the present disclosure. In some embodiments, estimating available free water, and subsequently plant weight, within a grow module from the above set of weight and linear acceleration measurements requires understanding how they interact and influence one another. Causal statistical models are a powerful tool that provide a framework for building graphs of variables and defining their effect on one another. This is denoted by the open arrows the tipping structural equation model (602), similar to “do calculus” notation.

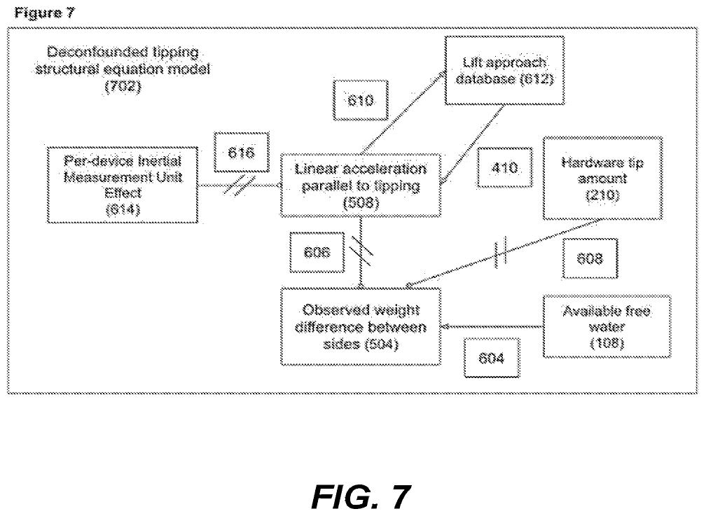

FIG. 7 illustrates an example of a deconfounded tipping structural equation model, in accordance with embodiments of the present disclosure. In some embodiments, a confounder can be removed from the graph to isolate quantities of interest. Removal of an effect is shown by a hashed line with an open circle in the deconfounded structural equation model (702). Removal of an effect can occur statistically by building a causal model of the effect and regressing it out, or can be made by physical hardware interventions.

In some embodiments, three variables affect observed weight difference between sides (504): linear acceleration to tipping (508), hardware tip amount (210), and available free water (108). Importantly, as denoted by directed arrows, changes in one quantity cause the change in the other. Once these effects are known and outlined, a single, direct link (604) between observed weight difference between sides (504) and available free water (108) can be made by removing the effect of confounders, linear acceleration to tipping (606) and hardware tip amount (608). Hardware tip amount confounder is removed by simply leaving it constant (608). The additional effect between linear acceleration parallel to tipping and observed weight difference between sides (606) is dealt with by statistical regressing out techniques.

In some embodiments, to improve the estimation of the effect (606) between linear acceleration parallel to tipping and observed weight difference between sides, the robotic lift approach (410) is chosen that increases grow hardware tip degrees (406) and subsequently increases water movement. According to the linear acceleration parallel to tipping observed previously, the optimal robot lift approach is written (610) to a lift approach database (612). During subsequent tipping runs, the optimal lift approach per location is loaded and used by the robotic movement and weighing system (204).

In some embodiments, given the same physical entity to measure, the IMU of each device (402) provides slightly different results, which confounds comparison of the linear acceleration parallel to tipping values (508) across multiple devices in the lift approach database (612). This per-device effect (614) can be controlled for (616) by calibrating the sensor. It is important to note that the per-device inertial measurement unit effect (614) does not influence observed weight difference between sides (504) because it is mediated through linear acceleration parallel to tipping (508), and regressed out as described above (606).

In some embodiments, in instances of a causal link defined above, one approach to isolate variables of interest is to build a statistical model of how one variable affects the other. There, specific subsets of observations of the relationship are gathered and a machine learning or statistical model is built.

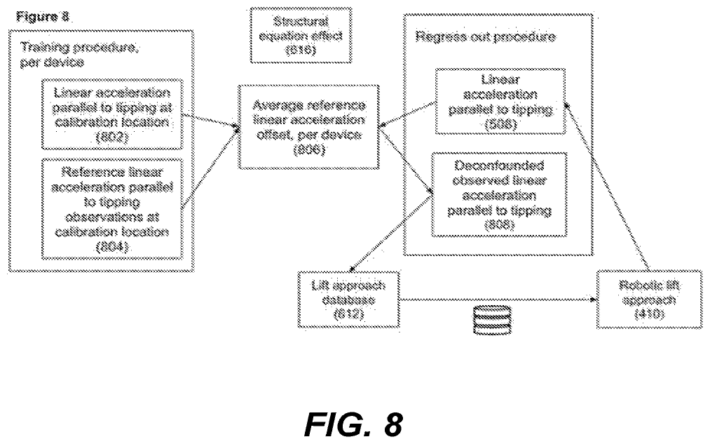

FIG. 8 illustrates an example of a structural equation effect model, m accordance with embodiments of the present disclosure. In some embodiments, to compare inertial measurement unit values across devices, the per-device inertial measurement unit effect (614) must be controlled for (616). Conditioned on the same location, a scalar, unknown constant is observed across multiple IMUs on different devices. Readings per device are different because the sensor may be mounted in differing orientations, or some other mechanism.

In some embodiments, the training procedure to remove the per-device inertial measurement unit effect (614) consists of collecting linear acceleration parallel to tipping values a_{ic} at a consistent reference location c (802), for a given device i. An additional linear acceleration parallel to tipping value at that same location is used (804), dir. An average reference linear acceleration offset o per device i (806) is then calculated as:

$${a}_{io} = \underline{{a}_{ic}} - {a}_{ir}$$

where a_{ic} is the average linear acceleration parallel to tipping values at a consistent reference location c (804), for a given device i.

In some embodiments, during inference time, to then remove the per-device inertial measurement unit effect, the average reference linear acceleration offset o per device i (806), aᵢₒ, is subtracted from the query linear acceleration parallel to tipping (508) at location q, resulting value is the deconfounded observed linear acceleration parallel to tipping (808) as

In some embodiments, this consensus linear acceleration value parallel to tipping, a_{q}, is then written to the lift approach database (612) per location q. Since the per-device inertial measurement unit effect has been removed from these values, they can be compared across multiple devices. This allows any new device to choose the optimal robotic lift approach (410) during subsequent tipping runs. Choice of robotic lift approach also affects future linear acceleration parallel to tipping acquisitions (508).

To make a direct link between observed weight difference between sides (504) and available free water (108), the effect of the linear acceleration parallel to tipping confounder (606) must be removed. This is done by building a statistical model that parameterizes the effect between linear acceleration parallel to tipping (508) and observed weight difference between sides (504).

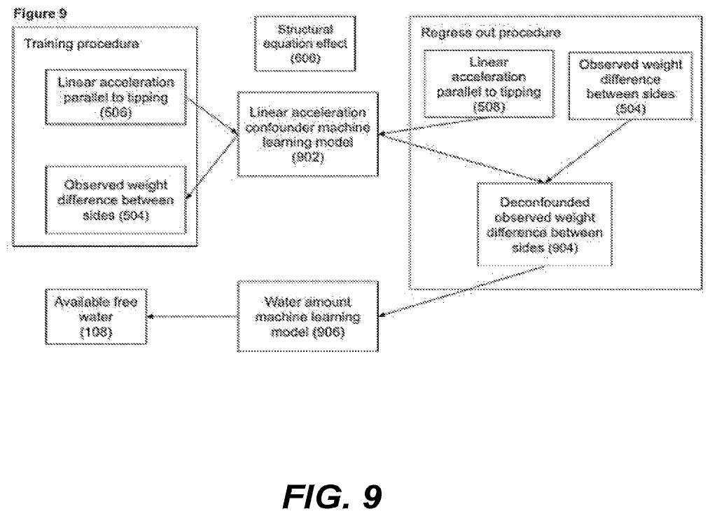

FIG. 9 illustrates another example of a structural equation effect model, in accordance with embodiments of the present disclosure. In some embodiments, a number paired observations of linear acceleration parallel to tipping (508) and observed weight difference between sides (504) of various grow modules are recorded for a given device i. These grow modules range a wide variety of available water (108) and linear acceleration parallel to tipping (508) that will be experienced during operations. A linear acceleration confounder machine learning model (902) is built using this data. In some embodiments, this model can be parameterized by linear regression, mapping the linear acceleration parallel to tipping (508) at query locations q to the square root of the expected difference in side weight e:

$$\sqrt{{e}_{q}} = {m}_{e} {a}_{q} + {b}_{e} + {ϵ}_{e}$$

It is important to note that model parameters me, be differ per device i, and must be fit empirically. This is likely due to latent biases between devices, sensors, and robot configurations. Because of this, a separate linear acceleration confounder machine learning model (902) is created per device i. While this model is parsimoniously fit with linear regression, this function could be fit with other supervised learning techniques, including but not limited to regression, kernel regression, decision tree, k-nearest neighbors, random forest, and deep learning.

In some embodiments, during inference time, when the confounder is to be removed, the amount of weight difference between sides is estimated from a query linear acceleration parallel to tipping value (508), and model parameters me, be fit earlier:

$$\sqrt{{e}_{q}} = {m}_{e} {a}_{q} + {b}_{e}$$

After squaring

$$\sqrt{} as {( \sqrt{} )}^{2} = ,$$

the estimated amount of weight difference between sides [symbol] is subtracted from the observed weight difference between sides e q:

$${\tilde{e}}_{q} = {e}_{q} -$$

This results in \tilde{e}_{q}, the deconfounded observed weight difference between sides (904). These steps are required to create a single link to available free water (108), which is estimated with a water amount machine learning model (906).

Now all observations in the directed model have been accounted for and can be readily observed by sensing components of an automated robotic system. To do this, a statistical model from deconfounded observed weight difference between sides (904) and free water (108) is built.

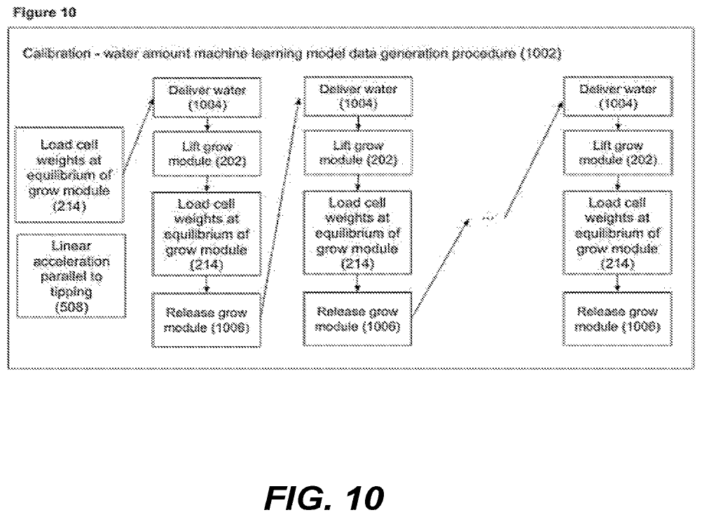

FIG. 10 illustrates an example of a data generation procedure calibration model, in accordance with embodiments of the present disclosure. Paired input data of both variables can be obtained through observations at specific times, locations, and conditions experienced by the lift robot. Taking advantage of known values of linear acceleration parallel to tipping (508) and available free water (108) provide a lens into a subset of observations where cause and effect can be statistically defined.

In some embodiments, a calibration procedure (1002) can be implemented to create a dataset in a highly reproducible and precise manner. A single reference location where the data acquisition will occur is chosen, and the linear acceleration parallel to tipping (508) is recorded there. Next, a grow module with zero water is weighed (512). Next, a known, precise amount of water is added (1004) to the growing tray (110). In some embodiments, the amount of water added is one liter, but it could be any amount up to a desired precision. In some embodiments, the water could be delivered in an automated fashion by an additional robot. The grow module is lifted (202), the water moves (208), and load cell weights are taken at water movement equilibrium (214). The grow module is then released (1006) and the process repeats again by delivering water (1004).

Since the calibration data generation procedure started with a tray with no water, the sum of all deliveries at that step in the process is the amount of water (108), with each receiving a paired load cell weights taken at water movement equilibrium (214).

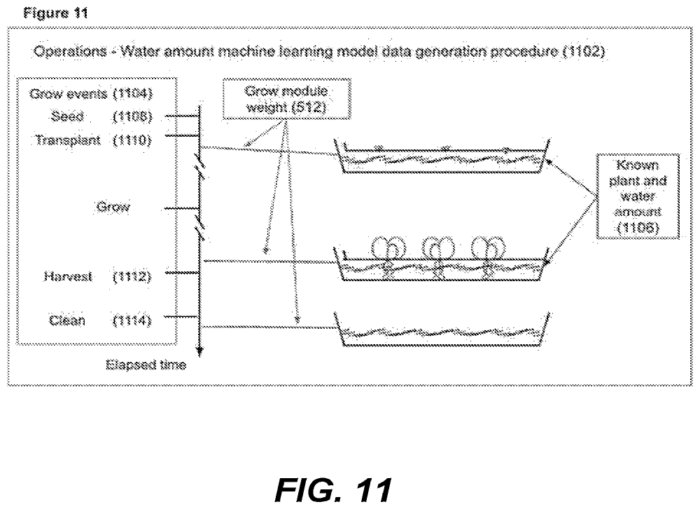

FIG. 11 illustrates an example of a data generation procedure operations model, in accordance with embodiments of the present disclosure. In some embodiments, operational procedures can permit grow module weights (1102) at times in the growing events cycle (1104) in which the plant weight (104) can be estimated by knowing either the plant or water weight (1106). This is possible because the grow module weights

(512) are taken throughout time of the growing cycle (1104) in accordance with other cycle events, including placing seeds in the grow hardware, seed (1108); moving the plants to the grow space, transplant (1110); harvesting leaves, harvest (1112); and removing the grow hardware and plants from the tray, clean (1114).

After a seed (1108) and transplant event (1110), plants are young and have very little weight-the plant weight (104) is considered negligible. Since the grow hardware (106) weight is constant, the remaining weight is water (108). Robot sensor data is taken under these constraints, where water (108) weight, observed difference between sides (504), and linear acceleration parallel to tipping values (508) are recorded. In some embodiments, this data is recorded if it is observed within 12 days of a transplant event (1110) and fifteen days after a seed event (1108) for a given grow module (102).

In some embodiments, grow module weights (512) can be recorded immediately before a harvest event (1112) and after a clean event (1114). Weights taken immediately before a harvest event (1112) are composed of the plant (104), available water (108), and growing tray (110) and plant support hardware (112) weights, respectively. Weights taken immediately after cleaning are composed of available water (108) and growing tray (110). Since the weight of the growing tray (110) is constant, the remaining weight is inferred to be available water (108). Plant weight (104) is subsequently derived from the weight taken immediately before harvest (1112) by subtracting constant grow hardware weight (106), as well as available water weight (108) derived previously. This plant weight is then paired with tipping robot sensor observations (502) from that module if the data acquisition was within two days of the harvest event (1112).

According to various embodiments, the calibration and operations based data provide a means of generating paired available water and robot sensor observations. In some embodiments, the causal link between deconfounded observed weight between sides (904) and available free water (108) can then be made with a water amount machine learning model (906).

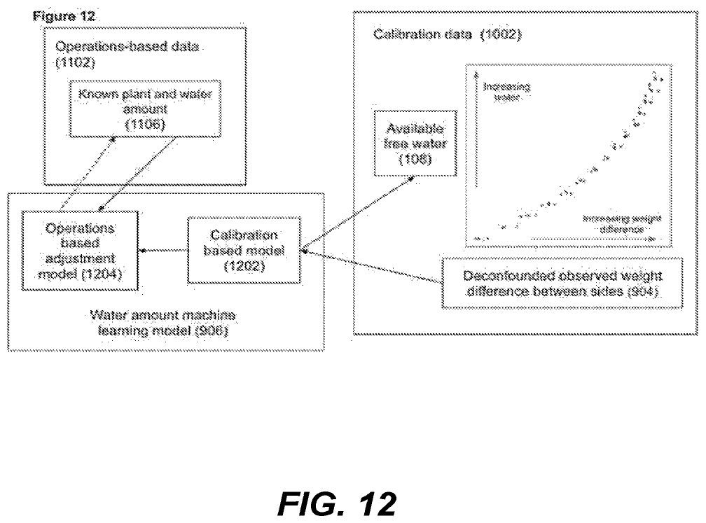

FIG. 12 illustrates an example of a machine learning model, in accordance with embodiments of the present disclosure. In some embodiments, the model consists of two components: A primary machine learning model trained on calibration data (1202), and a finetuning model trained on operations-based data that improves predictions from the calibration model (1204).

In some embodiments, the machine learning model is fit to calibration data maps paired with deconfounded observed weight difference between sides (904) and available free water (108), \tilde{e}_{c} and ŵ_{c}, respectively. This relationship is nonlinear, so a function h must be approximated with machine learning. In some embodiments, this function is approximated with k-nearest neighbors. However, this function could be fit with other supervised learning techniques, including but not limited to regression, kernel regression, decision tree, random forest, deep learning. The model is fit with the form:

$${w}_{c} = {h}_{c} ( {\tilde{e}}_{c} )$$

In some embodiments, once fit, the machine learning model trained on calibration data h_{c} transforms query data e_{q} to predicted available free water W_{cq}:

$$= {h}_{c} ( {\tilde{e}}_{q} )$$

In some embodiments, predicted plant weight p_{cq} can be subsequently calculated by subtracting the predicted available free water [symbol] from the total grow module weight (512):

$$= {t}_{cq} -$$

Next, the operations-based data is used to make a better prediction of available free water W_{f} by building a finetuning machine learning model, f. In some embodiments, free water is estimated by finetuning [symbol] with [symbol] , as generated from e_{f} using a trained calibration model h_{c}. This takes the form as linear regression:

$${w}_{f} = \hat{{w}_{cf}} + {m}_{f} + {b}_{f} + ϵ$$

In some embodiments, the parameter mf adjusts predicted free water by the initial estimate of plant weight. This factor likely improves predictions by taking into account water displaced by plant roots (1 04) in the growing tray (1 1 0), reducing the ability for water to move (208) as freely. Available free water is estimated as

$$= + {m}_{f} + {b}_{f}$$

Finally, predicted plant weight [symbol] for a query module can be estimated by subtracting the predicted available free water [symbol] from the total grow module weight (5 1 2). These two query weights [symbol] and [symbol] are used for downstream tasks, including but not limited to estimating the rate of plant growth over time; maintenance of water levels in a hydroponics grow system; and HPPOP010P 2 1.

It is important to note that operations-based data acquisition (1 1 02) occurs at a regular cadence through daily growing operations. In some embodiments, quality control can be performed by comparing values of w_{f} and p_{f} to the respective [symbol] and [symbol] . This allows constant assessment of performance of the water amount machine learning model (906).

Overall, in some embodiments, these methods for assessing free water from tipping a module assumes that tipping sensor observations (502) are recorded with perfect fidelity from the load cells (2 12) and IMU (402). However, in an industrial setting in the grow space, this may not be the case. Failures may occur when lifting the grow module (202), such as the grow module not sliding to the bottom of the alignment groove (306). Another source of failure is a grow module (1 02) not being fully picked up, as shown in (1 302). When these failures occur, the values recorded on the load cells may deviate from their expected values, which can be detected with additional quality control statistics.

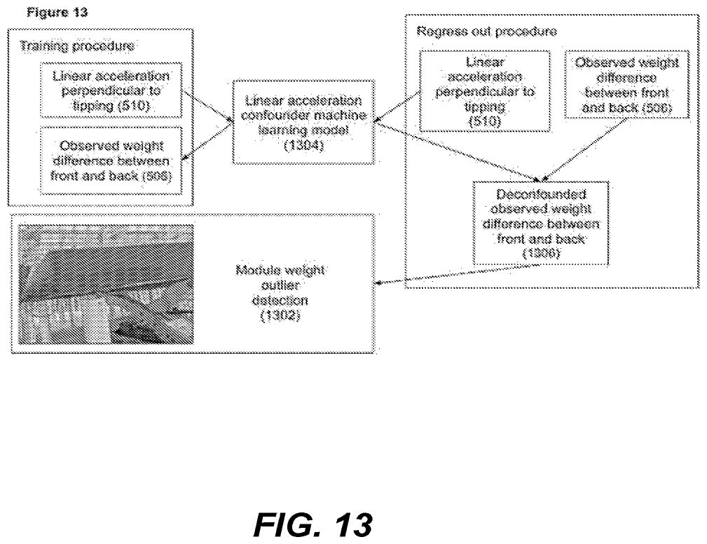

FIG. 13 illustrates an example of a quality control statistical model, in accordance with embodiments of the present disclosure. In some embodiments, deviations from expected load cell values can be estimated by statistics of the observed weight difference between front and back (506). Since water is not moving due to the asymmetric tipping hardware, changes in weight front to back are expected to be captured in the linear acceleration perpendicular to tipping (510).

In some embodiments, this model can be parameterized by linear regression, mapping the linear acceleration perpendicular to tipping á_{g} (1304) at query locations q to the square root of the expected difference in front-back weight v:

$$\sqrt{{v}_{q}} = {m}_{z} {{a}^{′}}_{q} + {b}_{z} + {ϵ}_{z}$$

In some embodiments, for simplicity, a separate linear acceleration confounder machine learning model (1304) is created per device i. This is the same parameterization as the model fit to linear acceleration parallel to tipping model (902), only fit to data from different sets of load cells.

### HPPOP010P 22

In some embodiments, during inference time, when the confounder is to be removed, the amount of weight difference between sides is estimated from a query linear acceleration perpendicular to tipping value (5 1 0), and model parameters m_{z}, b_{z} fit earlier:

$$\sqrt{} = {m}_{z} {{a}^{′}}_{q} + {b}_{z}$$

In some embodiments, after squaring

$$\sqrt{} as {( \sqrt{} )}^{2} = ,$$

the estimated amount of weight difference between sides [symbol] is subtracted from the observed weight difference between sides ν_{q}:

$${\tilde{v}}_{q} = {v}_{q} -$$

In some embodiments, this results in ν_{g}, the deconfounded observed weight difference between front and back (1 306). These values roughly follow a gaussian distribution, accordance to the variance of the data generating process ε_{z} and transformations therein. Any values of ν_{q} beyond a multiplier of the standard deviation of the noise ±ε_{z} are likely errors in the data acquisition process, and can be removed from downstream processing.

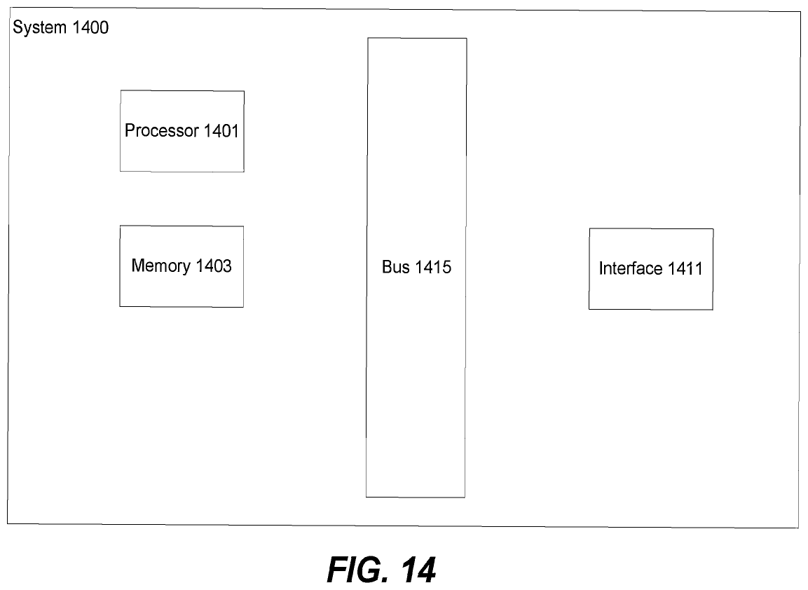

The examples described above present various features that utilize a computer system, for machine learning, or a robot that includes a computer. However, embodiments of the present disclosure can include all of, or various combinations of, each of the features described above. FIG. 14 illustrates one example of a computer system, in accordance with embodiments of the present disclosure. According to particular embodiments, a system 1400 suitable for implementing particular embodiments of the present disclosure includes a processor 1401, a memory 1403, an interface 1411, and a bus 1415 (e.g., a PCI bus or other interconnection fabric). When acting under the control of appropriate software or firmware, the processor 1401 is responsible for implementing applications such as an operating system kernel, a containerized storage driver, and one or more applications. Various specially configured devices can also be used in place of a processor 1401 or in addition to processor 1401. The interface 1411 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to var10 us embodiments, the system 1400 is a computer system configured to run a hydroponic grow system, as shown herein. In some implementations, one or more of the computer components may be virtualized. For example, a physical server may be configured in a localized or cloud environment. The physical server may implement one or more virtual server environments in which machine learning algorithms are executed. Although a particular computer system is described, it should be recognized that a variety of alternative configurations are possible. For example, the modules may be implemented on another device connected to the computer system.

In the foregoing specification, the present disclosure has been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure.

What is claimed is:

1. A method of determining plant weight, the method comprising:
picking up a tipping module to allow water to move while being tipped until the water settles to a weight equilibrium;
recording weight measurements once the water has reached weight equilibrium;
determining a module tipping angle measurement;
transforming the recorded weight measurements obtained at weight equilibrium into a deconfounded tipping module weight by using a machine learning model to remove the influence of the module tipping angle on the recorded weight measurements obtained at weight equilibrium;
transforming the deconfounded tipping module weight into a predicted water amount using a machine learning model trained on reference water volumes; and
obtaining plant weight by subtracting the predicted water amount from a total tipping module weight.

2. The method of claim 1, wherein a database of paired module tipping angle measurements and tipping module weights of tipping modules is used to map module tipping angle measurements to tipping module weights to estimate the influence of linear acceleration on tipping module weight.

3. The method of claim 1, wherein a reference database of previously observed module tipping angle measurements is used to inform the direction a tipping module is tipped.

4. The method of claim 1, wherein a module tipping angle reference calibration location is used to obtain device-based module tipping angle measurement biases, wherein the biases are subtracted from module tipping angle measurements stored in a reference linear acceleration database.

5. The method of claim 1, wherein stored reference pairs of water amounts and tipping module weights of a tipping module with no plants are used to train the machine learning model trained on reference water volumes, the reference pairs being stored at a reference calibration location.

6. The method of claim 1, wherein transforming the recorded weight measurements into a deconfounded tipping module weight includes one or more of the following:
weighing the tipping module;
weighing the tipping module when it is empty;
weighing the tipping module and plant support hardware;
weighing the tipping module immediately before harvest;
weighing the tipping module immediately after harvest; and
weighing the tipping module after harvest and after removal of the plant support hardware.

7. The method of claim 1, wherein a robot is used for picking up the tipping module and the module tipping angle measurement is derived using an inertial measurement unit (IMU) on the robot.

8. An apparatus comprising a computer processor, a computer memory operatively coupled to the computer processor, the computer memory having disposed within it computer program instructions that, when executed by the computer processor, cause the apparatus to carry out the steps of:
picking up a tipping module to allow water to move while being tipped until the water settles to a weight equilibrium;
recording weight measurements once the water has reached weight equilibrium;
determining a module tipping angle measurement;
transforming the recorded weight measurements obtained at weight equilibrium into a deconfounded tipping module weight by using a machine learning model to remove the influence of the module tipping angle on the recorded weight measurements obtained at weight equilibrium;
transforming the deconfounded tipping module weight into a predicted water amount using a machine learning model trained on reference water volumes; and
obtaining plant weight by subtracting the predicted water amount from a total tipping module weight.

9. The apparatus of claim 8, wherein a database of paired module tipping angle measurements and tipping module weights of tipping modules is used to map module tipping angle measurements to tipping module weights to estimate the influence of linear acceleration on tipping module weight.

10. The apparatus of claim 8, wherein a reference database of previously observed module tipping angle measurements is used to inform the direction a tipping module is tipped.

11. The apparatus of claim 8, wherein a module tipping angle reference calibration location is used to obtain device-based module tipping angle measurement biases, wherein the biases are subtracted from module tipping angle measurements stored in a reference linear acceleration database.

12. The apparatus of claim 8, wherein stored reference pairs of water amounts and tipping module weights of a tipping module with no plants are used to train the machine learning model trained on reference water volumes, the reference pairs being stored at a reference calibration location.

13. The apparatus of claim 8, wherein transforming the recorded weight measurements into a deconfounded tipping module weight includes one or more of the following:
weighing the tipping module;
weighing the tipping module when it is empty;
weighing the tipping module and plant support hardware;
weighing the tipping module immediately before harvest;
weighing the tipping module immediately after harvest; and
weighing the tipping module after harvest and after removal of the plant support hardware.

14. The apparatus of claim 8, wherein a robot is used for picking up the tipping module and the module tipping angle measurement is derived using an inertial measurement unit (IMU) on the robot.

15. A computer program product disposed upon a non-transitory computer readable medium, the computer program product comprising computer program instructions that, when executed, cause a computer to carry out the steps of:
picking up a tipping module to allow water to move while being tipped until the water settles to a weight equilibrium;
recording weight measurements once the water has reached weight equilibrium;
determining a module tipping angle measurement;
transforming the recorded weight measurements obtained at weight equilibrium into a deconfounded tipping module weight by using a machine learning model to remove the influence of the module tipping angle on the recorded weight measurements obtained at weight equilibrium;
transforming the deconfounded tipping module weight into a predicted water amount using a machine learning model trained on reference water volumes; and
obtaining plant weight by subtracting the predicted water amount from a total tipping module weight.

16. The computer program product of claim 15, wherein a database of paired module tipping angle measurements and tipping module weights of tipping modules is used to map module tipping angle measurements to tipping module weights to estimate the influence of linear acceleration on tipping module weight.

17. The computer program product of claim 15, wherein a reference database of previously observed module tipping angle measurements is used to inform the direction a tipping module is tipped.

18. The computer program product of claim 15, wherein a module tipping angle reference calibration location is used to obtain device-based module tipping angle measurement biases, wherein the biases are subtracted from module tipping angle measurements stored in a reference linear acceleration database.

19. The computer program product of claim 15, wherein stored reference pairs of water amounts and tipping module weights of a tipping module with no plants are used to train the machine learning model trained on reference water volumes, the reference pairs being stored at a reference calibration location.

20. The computer program product of claim 15, wherein transforming the recorded weight measurements into a deconfounded tipping module weight includes one or more of the following:
weighing the tipping module;
weighing the tipping module when it is empty;
weighing the tipping module and plant support hardware;
weighing the tipping module immediately before harvest;
weighing the tipping module immediately after harvest; and
weighing the tipping module after harvest and after removal of the plant support hardware.
